(19) United States
(12) Patent Application Publication
(10) Pub. No.: US 2025/0196360 A1
(43) Pub. Date: Jun. 19, 2025

(54) ROBOT SORTING METHOD BASED ON VISUAL RECOGNITION AND STORAGE MEDIUM

(71) Applicants: CHINA CONSTRUCTION STEEL STRUCTURE CORP., LTD., Guangdong (CN); CHINA CONSTRUCTION STEEL STRUCTURE GUANGDONG CO., LTD., Guangdong (CN)

(72) Inventors: Zhenming CHEN, Guangdong (CN); Yuntong XIAO, Guangdong (CN); Yongqiang WU, Guangdong (CN); Jiyou XIE, Guangdong (CN); Zhiyong ZUO, Guangdong (CN); Song DUAN, Guangdong (CN)

(21) Appl. No.: 18/294,345

(22) PCT Filed: Aug. 5, 2022
(86) PCT No.: PCT/CN2022/110680

§ 371 Date: Sep. 20, 2024

(30) Foreign Application Priority Data
Sep. 8, 2021 (CN) 202111048731.X

(51) Int. Cl. B25J 9/16; B25J 15/06; G06V 10/80

(52) U.S. Cl. CPC B25J 9/1697; B25J 9/1669; B25J 15/06; G06V 10/80

(57) ABSTRACT

The application relates to the technical field of visual guidance, and provides a robot sorting method based on visual recognition and a storage medium. All angles of an area to be sorted are fully covered by collecting grating images in a visual field range, so that an actual situation of the area to be sorted is determined. A grabbing space is defined to remove point clouds outside the grabbing space, reducing the computational data load and effectively lowering the system's operational burden. Contour feature data of a corresponding workpiece are obtained through a posture matrix, a posture of the workpiece is digitized, and a target grabbing sequence is determined through automatic comparison of the contour feature data of each workpiece, so that mechanical automatic sorting and grabbing are achieved, a part sorting and stacking method is unified, sorting work of a back-end procedure is reduced, an information flow in a sorting process is broken through, and traceability of the whole process is realized.

### TECHNICAL FIELD

The present disclosure relates to the technical field of visual guidance, and particularly to a robot sorting method based on visual recognition and a storage medium.

### BACKGROUND

In the traditional sorting process of steel structure parts, a sorting method for semi-finished parts commonly involves manually marking the parts and then randomly placing them in trays. Specifically, according to the information of parts in drawings such as typesetting drawings and lofting drawings issued by process designers, operators use paint markers to mark corresponding engineering names, work package names, specifications and dimensions, materials and subsequent processing paths on the front surfaces of the parts. Following the principle of stacking parts of the same specifications together, the parts are randomly placed in a tray space to complete the parts sorting and stacking operation. However, the above manual sorting and stacking present the following technical problems:

### (1) Restricted Production Efficiency

Parts in the same tray may have multiple processing paths and components corresponding to different production periods, leading to the need for secondary or even tertiary sorting in the later process. The copying of parts information has a large workload, and operations such as missed copying and wrong copying may occur, which cannot effectively improve the production efficiency.

### (2) Unclear Information Flow

Because each part is randomly sorted and stacked according to manual wishes, the production system cannot trace the component machining process, resulting in increased manual repetitive operations.

### SUMMARY

The present disclosure provides a robot sorting method based on visual recognition and a storage medium, which solve the technical problems of high labor cost, low production efficiency and high difficulty in tracing workpiece data in the existing manual sorting.

In order to solve the above technical problems, the present disclosure provides a robot sorting method based on visual recognition, which comprises:
S1: acquiring a plurality of grating images in a visual field range, and performing recognition and fusion to obtain point cloud set information;
S2: acquiring a posture matrix of each of workpieces in a grabbing space from the point cloud set information;
S3: acquiring contour feature data of each of the workpieces according to the posture matrix; and
S4: comparing the contour feature data of the workpieces, and determining a target grabbing sequence to grab the workpieces.

This basic solution can comprehensively cover all angles of an area to be sorted by collecting grating images in the visual field range, so as to determine an actual situation of the area to be sorted. A grabbing space is defined to remove point clouds outside the grabbing space, reducing the computational data load and effectively lowering the system's operational burden. Contour feature data of a corresponding workpiece are obtained through a posture matrix, a posture of the workpiece is digitized, and a target grabbing sequence is determined through automatic comparison of the contour feature data of each workpiece, so that mechanical automatic sorting and grabbing are achieved, a part sorting and stacking method is unified, sorting work of a back-end procedure is reduced, an information flow in a sorting process is broken through, and traceability of the whole process is realized.

In a further embodiment, S3 comprises:
S31: determining a contour curve and depth information of each of the workpieces according to the posture matrix; and
S32: analyzing a stacking degree according to the contour curve, and calculating a stacking index.

In a further embodiment, S32 comprises:
A: determining workpiece edges of each of the workpieces according to the contour curve;
B: determining a placing state of the workpiece as a first stacking parameter according to the depth information and the workpiece edges, and calculating a geometric center of the workpiece; and
C: calculating distances between the geometric center and the workpiece edges, selecting a smallest one of the distances as a second stacking parameter, and determining the stacking index of the workpiece in combination with the first stacking parameter;
wherein, the placing state comprises a natural putting state or a stacking state.

In this solution, the contour curve and the depth information of the workpiece can be determined according to the posture matrix obtained by recognition, and then whether the workpiece is in the stacking state (that is, the placing state) can be judged according to the fusion of the depth information and the contour curve, and the placing state is marked as the first stacking parameter: then, according to distances between a geometric center of an unstacked area of the workpiece and each workpiece edge, the smallest one of the distances is marked as the second stacking parameter. In this case, according to the first stacking parameter, the placing state of the corresponding workpiece can be quickly judged, and it may be known that a distance between the geometric center and a boundary of the stacked workpiece is inversely proportional to an overlapped area, so a stacking degree of the workpiece can be determined according to the second stacking parameter. In this solution, the grabbing and sorting are performed according to the stacking index of the workpiece, which can reduce the difficulty of grabbing and improve the efficiency of grabbing.

In a further embodiment, S4 comprises:
S41: sequentially determining a first priority, a second priority and a third priority of each of the workpieces in the grabbing space according to the depth information, the first stacking parameter and the second stacking parameter;
S42: determining a target grabbing sequence for each of the workpieces according to the first priority, the second priority and the third priority of each of the workpieces; and
S43: determining a product model according to the contour curve of the workpiece, and grabbing the workpieces according to the target grabbing sequence.

In a further embodiment, in S41:
the deeper the workpiece is, the lower the priority is: the workpiece in the natural putting state has a higher priority than the workpiece in stacking state; and the greater a numerical value of the second stacking parameter is, the higher the priority is; and
the first priority; the second priority and the third priority are sequentially decreased.

In this solution, the first priority, the second priority and the third priority are set according to the depth information, the first stacking parameter and the second stacking parameter respectively, so that the robot can grab the workpieces in an adaptive sequence according to the placing shapes of the workpieces, and grab the workpieces to a corresponding stacking area from top to bottom according to the product models, so that the robot is guided to complete some tasks involving identifying and grabbing disordered objects. This liberates people from repetitive and hazardous labor.

In a further embodiment, S1 comprises:
S11: projecting multiple sets of gratings with different phases to an area to be sorted in the visual field range, and acquiring corresponding grating images; and
S12: identifying the grating images, calculating coordinates of each feature point in the grating images by a triangulation location method, and integrating the coordinates to obtain the point cloud set information.

In a further embodiment, S2 comprises:
S21: setting the grabbing space according to a shape and a structure of an area to be sorted;
S22: screening the point cloud set information according to coordinate information of the grabbing space to obtain a target point cloud set; and
S23: performing outlier filtration on the target point cloud set, determining each visible workpiece in the grabbing space, and calculating the posture matrix of each visible workpiece in a camera coordinate system.

In a further embodiment, in S43, the grabbing the workpieces according to the target grabbing sequence, comprises:

determining the posture matrix of the current target grabbing workpiece according to the target grabbing sequence, converting the posture matrix into target grabbing coordinates in a manipulator coordinate system in combination with a hand-eye calibration matrix, and sending the target grabbing coordinates to a manipulator; and grabbing the target grabbing workpiece according to the target grabbing coordinates by the manipulator.

In a further embodiment, the manipulator is a magnetic suction manipulator.

In this solution, the magnetic suction manipulator is used to grab the workpiece, which allows not only control over the grabbing force but also prevents any damage to the workpieces during the grabbing process.

The present disclosure further provides a storage medium storing a computer program thereon, wherein the computer program is configured to achieve the above-mentioned robot sorting method based on visual recognition. The storage medium may be a magnetic disk, an optical disk, a Read Only Memory (ROM), or a Random Access Memory (RAM), and the like.

### BRIEF DESCRIPTION OF THE DRAWINGS

FIG. 1 is a workflow diagram of a robot sorting method based on visual recognition provided by the embodiments of the present disclosure;

FIG. 2 is a schematic diagram of a grabbing space provided by the embodiments of the present disclosure:

FIG. 3 is a top view of the grabbing space provided by the embodiments of the present disclosure;

FIG. 4 is a target point cloud set provided by the embodiments of the present disclosure:

FIG. 5 is a point cloud of a workpiece after filtering processing provided by the embodiments of the present disclosure:

FIG. 6 is a schematic diagram of a posture of a workpiece provided by the embodiments of the present disclosure; and

FIG. 7 is a schematic diagram of stacking of a plurality of workpieces provided by the embodiments of the present disclosure.

### DETAILED DESCRIPTION

The embodiments of the present disclosure will be described in detail below with reference to the accompanying drawings. The embodiments are given for illustration purposes only, and cannot be understood as limitations of the present disclosure. The accompanying drawings are for reference and illustration purposes only, and do not constitute limitations on the protection scope of the present disclosure as many changes can be made to the present disclosure without departing from the gist and scope of the present disclosure.

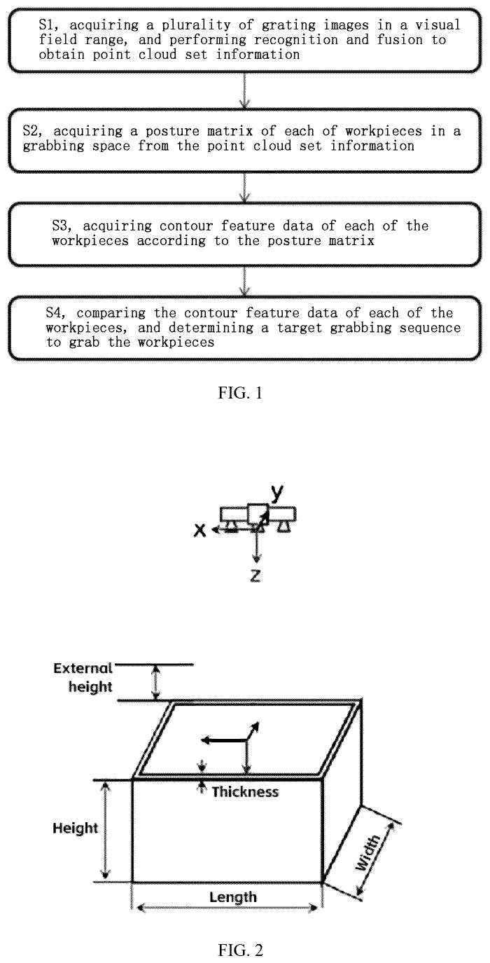

A robot sorting method based on visual recognition provided by the embodiments of the present disclosure, as shown in FIG. 1, comprises S1 to S4:
S1: acquiring a plurality of grating images in a visual field range, and performing recognition and fusion to obtain point cloud set information, comprising S11 to S12:
S11: projecting multiple sets of gratings with different phases to an area to be sorted in the visual field range, and acquiring corresponding grating images; and
S12: identifying the grating images, calculating coordinates of each feature point in the grating images by a triangulation location method, and integrating the coordinates to obtain the point cloud set information.
S2: acquiring a posture matrix of each of workpieces in a grabbing space from the point cloud set information, comprising S21 to S23:
S21: setting the grabbing space according to a shape and a structure of an area to be sorted.

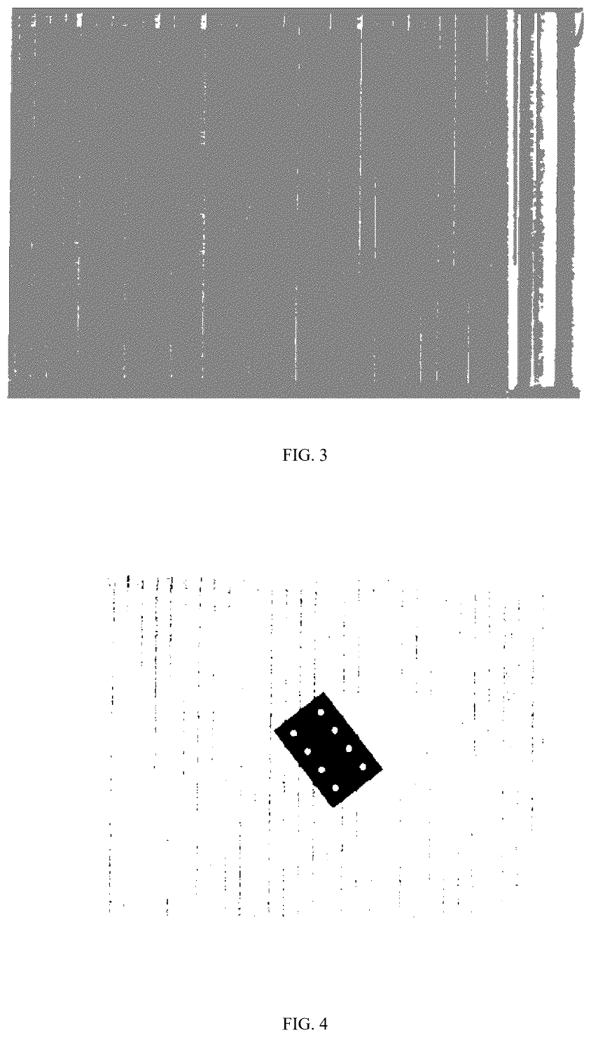

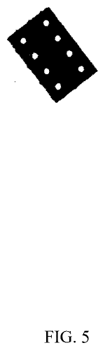

Specifically, referring to FIG. 2, in this embodiment, the area to be sorted is a storage frame, and the workpieces are stacked in the storage frame. Therefore, taking an image acquisition element (camera) as a central point and defining the grabbing space according to a length and a width of the storage frame, the collected image area is a color block area in the middle of FIG. 3.
S22: screening the point cloud set information according to coordinate information of the grabbing space to obtain a target point cloud set, as shown in FIG. 4; and
S23: referring to FIG. 5, performing outlier filtration on the target point cloud set, determining each visible workpiece in the grabbing space, and calculating the posture matrix of each visible workpiece in a camera coordinate system.

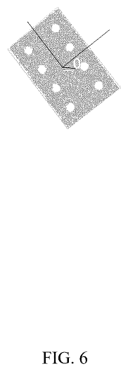

An image of the workpiece finally obtained is shown in FIG. 6.
S3: acquiring contour feature data of each of the workpieces according to the posture matrix, comprising S31 to S32:
S31: determining a contour curve and depth information of each of the workpieces according to the posture matrix; and
S32: analyzing a stacking degree according to the contour curve, and calculating a stacking index, comprising A to C:
A: determining workpiece edges of each of the workpieces according to the contour curve;
B: determining a placing state of the workpiece as a first stacking parameter according to the depth information and the workpiece edges, and calculating a geometric center of the workpiece; and
C: calculating distances between the geometric center and the workpiece edges, selecting a smallest one of the distances as a second stacking parameter, and determining the stacking index of the workpiece in combination with the first stacking parameter;
wherein, the placing state comprises a natural putting state or a stacking state.

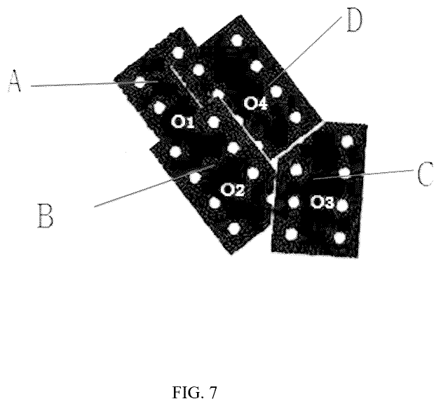

In this embodiment, referring to FIG. 7, when the contour curves of a plurality of workpieces stacked with each other are recognized, a preset tolerance corresponding to the depth information may be set, and whether each boundary is the actual workpiece edge of the workpiece may be judged according to the point cloud data. When it is judged that all workpiece edges of the workpiece meet the preset tolerance, the workpiece is judged to be in a natural placing state: otherwise the workpiece is judged to be in a stacking state, and the first stacking parameter is determined. In FIG. 7, it is recognized that the first stacking parameters of four workpieces are all stacking states.

In this case, the geometric center O of the workpiece is calculated, and the position coordinates of the workpiece are determined according to the point cloud information. Then, the distances between the geometric center O and each workpiece edge are calculated, and the smallest one of the distances is selected as the second stacking parameter.

In other embodiments, using the method in the existing technology, the geometric center of the uncovered area of the workpiece may be calculated, the position coordinates may be determined according to the point cloud information, and then the distances between the geometric center O and each workpiece edge may be calculated, and the smallest one of the distances may be selected as the second stacking parameter.

The first stacking parameter and the second stacking parameter are the stacking indexes.

In this embodiment, the contour curve and the depth information of the workpiece can be determined according to the posture matrix obtained by recognition, and then whether the workpiece is in the stacking state (that is, the placing state) can be judged according to the fusion of the depth information and the contour curve, and the placing state is marked as the first stacking parameter; then, according to distances between a geometric center of the workpiece and each workpiece edge, the smallest one of the distances is marked as the second stacking parameter. In this case, according to the first stacking parameter, the placing state of the corresponding workpiece can be quickly judged, and it may be known that a distance between the geometric center and a boundary of the stacked workpiece is inversely proportional to an overlapped area, so a stacking degree of the workpiece can be determined according to the second stacking parameter. In this solution, the grabbing and sorting are performed according to the stacking index of the workpiece, which can reduce the difficulty of grabbing and improve the efficiency of grabbing.

S4: comparing the contour feature data of the workpieces, and determining a target grabbing sequence to grab the workpieces, comprising S41 to S43:
S41: sequentially determining a first priority, a second priority and a third priority of each of the workpieces in the grabbing space according to the depth information, the first stacking parameter and the second stacking parameter; and
S42: determining a target grabbing sequence for each of the workpieces according to the first priority, the second priority and the third priority of each of the workpieces.

In this embodiment:
the deeper the workpiece is, the lower the priority is: the workpiece in the natural putting state has a higher priority than the workpiece in stacking state; and the greater a numerical value of the second stacking parameter is, the higher the priority is; and
the first priority, the second priority and the third priority are sequentially decreased.

Specifically, referring to FIG. 7, four workpieces A, B, C and D are taken as examples, wherein o1, o2, o3 and o4 are geometric centers of the workpieces A, B, C and D respectively, and the corresponding second stacking parameters thereof are a, b, c and d respectively, as shown in Table 1 below.

TABLE 1

| Serial number | First priority | Second priority | Third priority |
|---|---|---|---|
| A | 2 | Stacking state | a |
| B | 1 | Stacking state | b |
| C | 1 | Stacking state | c |
| D | 1 | Stacking state | d |

When conducting the grabbing prioritization, the first priority, the second priority and the third priority are compared in turn. Firstly, for the first priority, the priority of the workpiece A is lower than that of the workpieces B, C and D, making it the last one to be grabbed. Moving on to the second priority, the priorities of the workpieces B, C and D are all in the stacking state, so we proceed to compare the third priority. When comparing the third priority, the grabbing sequence is arranged according to the sequence of b, c and d from largest to smallest.

For example, if b>c>d, the grabbing sequence of the workpieces A, B, C and D is as follows: the workpiece B, the workpiece C, the workpiece D and the workpiece A.

S43: determining a product model according to the contour curve of the workpiece, and grabbing the workpieces according to the target grabbing sequence.

In this embodiment, the grabbing the workpieces according to the target grabbing sequence comprises:
determining the posture matrix of the current target grabbing workpiece according to the target grabbing sequence, converting the posture matrix into target grabbing coordinates in a manipulator coordinate system in combination with a hand-eye calibration matrix, and sending the target grabbing coordinates to a manipulator; and grabbing the target grabbing workpiece according to the target grabbing coordinates by the manipulator.

In this embodiment, the first priority, the second priority and the third priority are set according to the depth information, the first stacking parameter and the second stacking parameter respectively, so that the robot can grab the workpieces in an adaptive sequence according to the placing shapes of the workpieces, and grab the workpieces to corresponding stacking areas from top to bottom according to the product models, so that the robot is guided to complete some tasks involving identifying and grabbing disordered objects. This liberates people from repetitive and hazardous labor.

In this embodiment, the manipulator is a magnetic suction manipulator.

In this embodiment, the magnetic suction manipulator is used to grab the workpiece, which allows not only control over the grabbing force but also prevents any damage to the workpieces during the grabbing process.

The embodiments of the present disclosure can comprehensively cover all angles of an area to be sorted by collecting grating images in the visual field range, so as to determine an actual situation of the area to be sorted. A grabbing space is defined to remove point clouds outside the grabbing space, reducing the computational data load and effectively lowering the system's operational burden. Contour feature data of a corresponding workpiece are obtained through a posture matrix, a posture of the workpiece is digitized, and a target grabbing sequence is determined through automatic comparison of the contour feature data of each workpiece, so that mechanical automatic sorting and grabbing are achieved, a part sorting and stacking method is unified, sorting work of a back-end procedure is reduced, an information flow in a sorting process is broken through, and traceability of the whole process is realized.

### Embodiment 2

The embodiments of the present disclosure further provide a storage medium storing a computer program thereon, wherein the computer program is used to realize the robot sorting method based on visual recognition described in Embodiment 1 above. The storage medium may be a magnetic disk, an optical disk, a Read Only Memory (ROM), or a Random Access Memory (RAM), and the like.

The above embodiments are preferred embodiments of the present disclosure, but the embodiments of the present disclosure are not limited to the above embodiments, and any other changes, modifications, substitutions, combinations, and simplifications made without departing from the spirit and scope of the present disclosure should be equivalent replacement means, and are included in the protection scope of the present disclosure.

What is claimed is:

1. A robot sorting method based on visual recognition, comprising:
S1: acquiring a plurality of grating images in a visual field range, and performing recognition and fusion to obtain point cloud set information;
S2: acquiring a posture matrix of each of workpieces in a grabbing space from the point cloud set information;
S3: acquiring contour feature data of each of the workpieces according to the posture matrix; and
S4: comparing the contour feature data of the workpieces, and determining a target grabbing sequence to grab the workpieces.

2. The robot sorting method based on visual recognition according to claim 1, wherein S3 comprises:
S31: determining a contour curve and depth information of each of the workpieces according to the posture matrix; and
S32: analyzing a stacking degree according to the contour curve, and calculating a stacking index.

3. The robot sorting method based on visual recognition according to claim 2, wherein S32 comprises:
A: determining workpiece edges of each of the workpieces according to the contour curve;
B: determining a placing state of the workpiece as a first stacking parameter according to the depth information and the workpiece edges, and calculating a geometric center of the workpiece; and
C: calculating distances between the geometric center and the workpiece edges, selecting a smallest one of the distances as a second stacking parameter, and determining the stacking index of the workpiece in combination with the first stacking parameter;
wherein, the placing state comprises a natural putting state or a stacking state.

4. The robot sorting method based on visual recognition according to claim 3, wherein S4 comprises:
S41: sequentially determining a first priority, a second priority and a third priority of each of the workpieces in the grabbing space according to the depth information, the first stacking parameter and the second stacking parameter;
S42: determining a target grabbing sequence for each of the workpieces according to the first priority, the second priority and the third priority of each of the workpieces; and
S43: determining a product model according to the contour curve of the workpiece, and grabbing the workpieces according to the target grabbing sequence.

5. The robot sorting method based on visual recognition according to claim 4, wherein in S41:
the deeper the workpiece is, the lower the priority is: the workpiece in the natural putting state has a higher priority than the workpiece in stacking state; and the greater a numerical value of the second stacking parameter is, the higher the priority is; and
the first priority, the second priority and the third priority are sequentially decreased.

6. The robot sorting method based on visual recognition according to claim 1, wherein S1 comprises:
S11: projecting multiple sets of gratings with different phases to an area to be sorted in the visual field range, and acquiring corresponding grating images; and
S12: identifying the grating images, calculating coordinates of each feature point in the grating images by a triangulation location method, and integrating the coordinates to obtain the point cloud set information.

7. The robot sorting method based on visual recognition according to claim 1, wherein S2 comprises:
S21: setting the grabbing space according to a shape and a structure of an area to be sorted;
S22: screening the point cloud set information according to coordinate information of the grabbing space to obtain a target point cloud set; and
S23: performing outlier filtration on the target point cloud set, determining each visible workpiece in the grabbing space, and calculating the posture matrix of each visible workpiece in a camera coordinate system.

8. The robot sorting method based on visual recognition according to claim 4, wherein in S43, the grabbing the workpieces according to the target grabbing sequence, comprises:
determining the posture matrix of a current target grabbing workpiece according to the target grabbing sequence, converting the posture matrix into target grabbing coordinates in a manipulator coordinate system in combination with a hand-eye calibration matrix, and sending the target grabbing coordinates to a manipulator; and grabbing the target grabbing workpiece according to the target grabbing coordinates by the manipulator.

9. The robot sorting method based on visual recognition according to claim 8, wherein the manipulator is a magnetic suction manipulator.

10. A storage medium storing a computer program thereon, wherein the computer program is used to realize the robot sorting method based on visual recognition according to claims 1 to 9.
